(19) United States
(12) Patent Application Publication
(10) Pub. No.: US 2008/0314770 A1
(43) Pub. Date: Dec. 25, 2008

(54) Carton With Access Feature

(76) Inventor: Jean-Michel Auclair, Chateauroux (FR)

Correspondence Address: MEADWESTVACO CORPORATION, 1021 MAIN CAMPUS DRIVE, CENTENNIAL CAMPUS, RALEIGH, NC, 27606, US

(21) Appl. No.: 12/067,444

(22) PCT Filed: Sep. 19, 2006
(86) PCT No.: PCT/US06/36518

§ 371 Date: Sep. 4, 2008

(30) Foreign Application Priority Data
Sep. 19, 2005 (GB) 0519057.4
Nov. 3, 2005 (GB) 0522469.6

(51) Int. Cl. B65D 75/00; B65D 17/00; B31B 1/50

(52) U.S. Cl. 206/155; 229/207; 493/183

(57) ABSTRACT

A carton for packaging articles arranged in rows, includes a top panel (16/66), side panels (12/14, 18/20), a bottom panel (10/22) and an integral tear-open access feature (16/62/66) provided by the top panel and one of the side panels to gain access to the contents. The tear-open access feature is hingedly connected to the carton. When the carton is placed on the other side panel (18/20), the tear open access feature is foldable to be disposed in part in contact with the other side panel and in part spaced from the other side panel to provides a platform structure for enhancing the stability of the carton.

### FIELD OF INVENTION

The present invention relates to a carton for containing articles, and more particularly, although not exclusively, to cartons that are for accommodating bottles.

### BACKGROUND OF THE INVENTION

Packages for packaging multiple articles that provide an opening feature are well known, such as that in EP 1360116, which discloses a carton where access can be gained to the articles within it. It is further known, from U.S. Pat. No. 6,345,759, to provide tapered cartons for containing articles, particularly, although not exclusively, when the articles themselves are tapered. It is desirable to provide a carton which has an access feature which allows the articles to be accessed whilst also displaying the contents of the carton. This allows the identity and remaining number of articles to be determined. It is also desirable to prevent the unintentional egress of articles from the carton. A key factor in mitigating such unintentional egress is that of providing as high a degree of stability in the carton as possible. Such stability is, however, often compromised by the shape of the carton. As an example, a gable top carton has an upper portion which is tapered. If such a carton was to be laid upon its side, in order to dispense its contents, it would possess a lowermost edge about which the entire carton may pivot in response to downward force upon one end and this action could cause the contents to fall out of the carton.

The present invention seeks to overcome, or at least mitigate, such issues of preventing unintentional egress of articles from a carton.

### SUMMARY OF INVENTION

A first aspect of the present invention provides a carton for packaging articles arranged in rows which carton comprises a top panel, side panels, a bottom panel and an integral tear-open access means provided by said top panel and one of said side panels to gain access to said article, said integral tear-open access means being permanently hingedly connected to said carton about a first fold line, and wherein when said carton is orientated upon a surface such that a side panels is lowermost, and wherein said integral tear open access means being foldable about said first fold line to contact said side panel in such a manner that said tear open access means provides a part of a platform structure which enhances the stability of the carton.

Preferably, the part of the platform structure is disposed internally of said carton and provides a support for one end of one or more of said articles which otherwise are resting on the lowermost side panel.

Preferably, the part of the platform structure together with facing parts of the lowermost side panel forms the platform structure that is generally uniform.

Preferably, said articles are supported upon an edge created by folding the access means about a second fold line which second fold line is defined within the tear open access means.

Preferably, the terminal edge of the tear open access means, opposed said first fold line, is positioned between the remaining contents of the carton and the lowermost side panel.

Preferably, the weight of the said one end of one or more of said articles deforms said side panel.

Preferably, a web arrangement of gusset panels between adjacent panels of said carton allows at least a part of said side panel that is lowermost to deform in such a manner that a substantial part of said side panel comes into face contacting relationship with said surface.

Preferably, said web arrangement comprises first and second gusset panels hingedly connected to one another about one common edge, wherein an edge of said first gusset panel opposed from said common edge is hingedly connected to a first panel of the carton, and wherein an edge of said second gusset panel opposed from said common edge is hingedly connected to a second panel of the carton, and wherein said first and second panels of the carton are adjacent to one another.

As a further option to this first aspect, said part of the platform structure is positioned externally of the carton and serves to space some portion of the lowermost side panel from some portion of said surface.

Preferably, a terminal edge of the access means, opposed said first fold line, engages with the lowermost side panel of the carton.

Preferably, the lowermost side panel of the carton comprises one or more apertures with which some portion of said terminal edge of said access means is adapted to engage.

Preferably, a terminal edge of said access means incorporates one or more finger tabs.

Preferably, said finger tabs are arranged to facilitate separation of the access means from said side panels and said top panel of said carton.

A second aspect of the present invention providing carton for packaging articles arranged in rows which carton comprises a top panel, side panels, a bottom panel and an integral tear-open access means provided by said top panel and one of said side panels to gain access to the said articles, said tear-open access means being permanently hingedly connected about a first fold line, and wherein when said carton is orientated upon a surface such that one of said side panels is lowermost, said access means being hingedly connected about said first and an adjacent second fold line to form a part of the platform structure generally spaced from the said one of said side panels and disposed internally or externally of the carton, which platform structure enhances the stability of the carton.

Preferably, said part of the platform structure is disposed internally of said carton and provides a support for one end of one or more of said articles which otherwise are resting on said the lowermost side panel.

Preferably, said part of the platform structure, together with facing parts of the lowermost side panel, forms the platform structure that is generally uniform.

A third aspect of the present invention providing a tear open access feature for use in a carton wherein said access feature is struck from panels of said carton and defined within said panels between at least one frangible line and a first fold line, said frangible line being breakable to allow a user to gain access to articles contained within said carton, said access feature being hingedly connected to said carton by said first fold line, said access feature comprising a second fold line such that said access means can be folded about said second fold line in order to place a portion of the access feature between said articles and a panel of said carton, thereby providing support for the carton contents.

Preferably, said second fold line is parallel to said first fold line.

Preferably, said access feature comprises a finger tab to facilitate breaking said frangible line.

A fourth aspect of the present invention providing a blank for forming a carton comprising the access feature described above.

A fifth aspect of the present invention providing a blank for forming a carton comprising a linear series of panels for forming a top, opposed side and bottom panels of a set up carton, wherein the blank further comprises an integral tear-open access means provided by said top panel and one of said side panels of the set up carton to gain access articles contained within the set up carton, said tear-open access means being permanently hingedly connected to said set up carton about a first fold line, and wherein when said set up carton is orientated upon a surface such that a side panel is lowermost, and wherein said tear open access means is foldable about said first fold line to contact the lowermost side panel in such a manner that said tear open access means provides a part of the platform structure which enhances the stability of the carton.

Preferably, the blank further comprises a web arrangement of gusset panels, wherein said web arrangement permits deformation of said set up carton.

Preferably, said web arrangement comprises first and second gusset panels hingedly connected to one another about one common edge, wherein an edge of said first gusset panel opposed from said common edge is hingedly connected to a first panel of the set up carton, and wherein an edge of said second gusset panel opposed from said common edge is hingedly connected to a second panel of said set up carton, and wherein said first and second panels of said set up carton are adjacent one another.

A sixth aspect of the present invention providing a carton substantially as described herein before with reference to the accompanying figures.

A seventh aspect of the present invention providing a blank substantially as described herein before with reference to the accompanying figures.

An eighth aspect of the present invention providing an access means substantially as described herein before with reference to the accompanying figures.

### BRIEF DESCRIPTION OF THE DRAWINGS

Two exemplary embodiments of the present invention will now be described by way of reference only to the accompanying drawings:

FIG. 1 illustrates a plan view of a blank from which a carton can be assembled according to a first preferred embodiment of the invention,

FIG. 2 illustrates perspective view of a carton constructed from the blank of FIG. 1 according to a first preferred embodiment of the present invention,

FIG. 3 illustrates a perspective view of the carton of FIG. 2 wherein an access feature has been opened to gain access to the carton contents,

FIG. 4 illustrates a perspective view of the carton of FIG. 2 when a portion of the access feature has been folded into contact with the carton contents,

FIG. 5 illustrates a view of the carton according to FIG. 4 wherein the carton has been orientated upon a side panel,

FIG. 6 illustrates a cross sectional view of the carton access feature of FIG. 3 when in operation.

FIG. 7 illustrated a plan view of a blank from which a carton can be assembled according to a second preferred embodiment of the invention,

FIG. 8 illustrates perspective view of a carton constructed from the blank of FIG. 7 according to a second preferred embodiment of the present invention,

FIG. 9 illustrates a perspective view of the carton of FIG. 8 wherein an access feature has been opened to gain access to the carton contents,

FIG. 10 illustrates a perspective view of the carton of FIG. 8 when a portion of the access feature has been folded into contact with the carton contents,

FIG. 11 illustrates a view of the carton according to FIG. 10 wherein the carton has been orientated upon a side panel,

FIG. 12 illustrates a cross sectional view of the carton access feature of FIG. 9 when in operation.

### DETAILED DESCRIPTION OF THE PREFERRED EMBODIMENTS

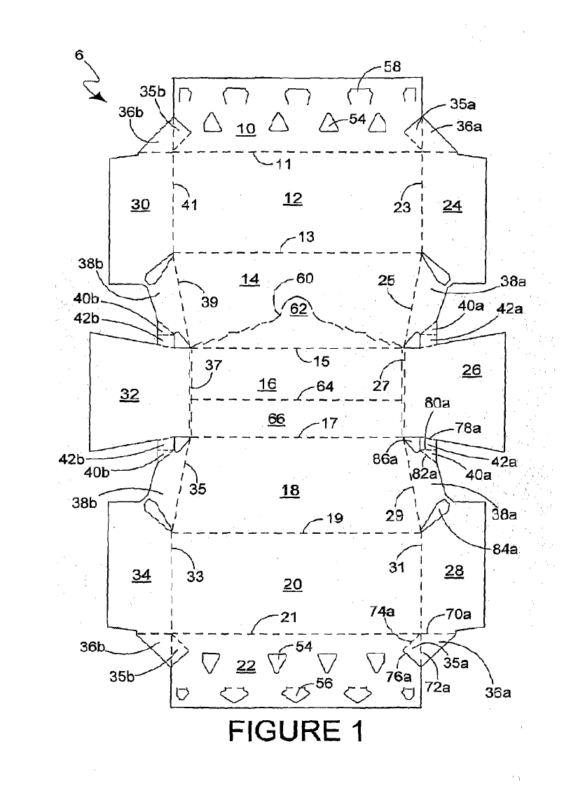

FIG. 1 illustrates a plan view of a carton blank 6 according to a first preferred embodiment of the invention.

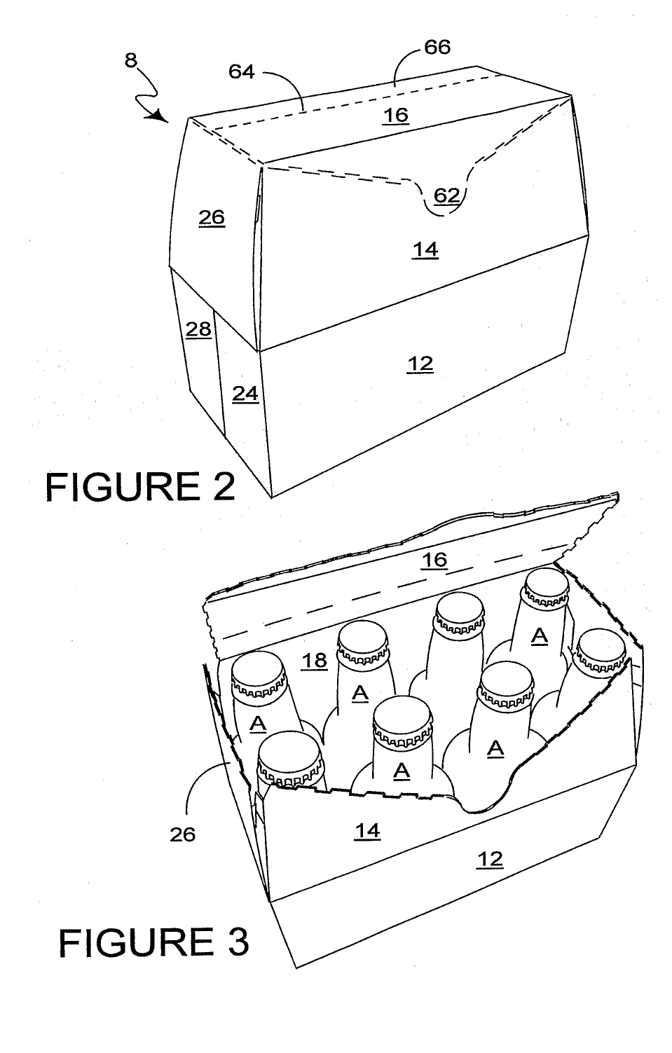

The blank 6 comprises a linear series of main panels 10, 12, 14, 16, 18, 20 and 22 interconnected by fold lines 11, 13, 15, 17, 19, 21 respectively. Panels 10 and 22 at each end of the linear series comprise apertures 54 suitable for being engaged by a packaging machine for bringing panels 10 and 22 into at least partial overlapping relationship during construction of the carton. Panel 10 comprises a first part 58 of a complementary locking mechanism and panel 22 comprises a second part 56 of the complementary locking mechanism. Panels 10 and 22 may be secured to one another by means of the complementary locking mechanism 56, 58 to form a composite base of a setup carton 8, illustrated in FIG. 2.

Panels 12, 14, 18, 20 form side panels, where panels 12 and 20 form lower side panels and panels 14 and 18 form upper side panels being disposed at an angle inwardly, towards each other, in a setup carton 8 as shown in FIG. 2.

Top panel 16 is disposed between upper side panel 14 and upper side panel 18 which are each hingedly connected to the top panel 16 on opposed sides along fold lines 15 and 17 respectively. Furthermore, top panel 16 is hingedly connected along either end to top end panels 26 and 32, along frangible lines 27 and 37 respectively. Defined within top panel 16, is a region 66 which forms an integral part of the access means as illustrated in FIG. 3 and described in further detail below.

Lower end flaps 24, 30 are hingedly connected along fold lines 23 and 41 respectively to opposed ends of lower side panel 12. Similarly lower end flaps 28, 34 are hingedly connected along fold lines 31 and 33 respectively to lower side panel 20. Web structures 35a/36a, 35b/36b hinge the lower end flaps 24, 28, 30, 34 to composite base panel 10, 22 formed from securing panel 10 to panel 22. Each web structure 35a/36a, 35a/35b is substantially the same and will be described by reference to only one of them.

Web panel 36a is hingedly connected to the base panel 22 and also hingedly connected to lower end flap 28. A relief panel 35a is struck from base panel 22. Relief panel 35a is hingedly connected to web panel 36a and hingedly connected to base panel 22 along a fold line 74a. Fold line 74a extends into base panel 22 from a first end disposed at a vertex shared by base panel 22, lower side panel 20 and lower end flap 28. A cut line 76a extends from the other end of fold line 74a to a free edge of the base panel 22 coincident with the point at which web panel 36a hinges to the base panel 22. This cut line 76a allows the relief panel to fold out of the plane of base panel 22 in response to folding of lower end flap 28 and lower side panel 20 as the carton 8 is being set up.

Upper end flaps 38a and 38b are hingedly connected to opposing ends of upper side panels 18. Similarly a second set of upper end flaps 38a and 38b are hingedly connected to oppose ends of upper side panel 14. The upper end flaps 38a, 38b are of substantially the same construction and will be described by reference to only one example.

Upper end flap 38a is hingedly connected to upper side panel 18 along fold line 29 and to lower end flap 28 along a portion of the free edge adjacent the fold line 29. The hinged portion of the free edge being disposed substantially at the free edge opposed to fold line 29.

Upper end flap 38a is hingedly connected via web arrangement 40a/42a, 40b/42b to top end flap 26. The web arrangement 40a/42a, 40b/42b comprises first gusset panel 40a which is hingedly connected by fold line 82a to a portion of the free edge of upper end flap 38a adjacent the top end flap 26. First gusset panel 40a is hingedly connected to a second gusset panel 42a along fold line 80a; second gusset panel 42a is hingedly connected to a portion of top end flap 26 along fold line 78a.

Top panel 16 comprises a fold line 64 extending between the frangible lines 27.

Upper side panel 14 comprises a frangible line 60 which originates at the vertex shared by top end flap 32, top panel 16, upper end flap 38b and upper side panel 14. The frangible line 60 terminates at the vertex shared by top end flap 26, upper end flap 38a, top panel 16 and upper side panel 14.

The frangible line 60 extends into upper side panel 14 in a generally v-shaped manner. A portion of the frangible line 60 defines a finger engaging tab 62 in the upper side panel 14. Frangible line 60 forms a continuous frangible line with frangible lines 27 and 37. The finger engaging tab 62 can be engaged by a user to break the frangible lines 60, 27, 37. An access means is defined between frangible lines 60, 27, 37 and fold line 17 that allows a user to gain access to the articles A contained within the set up carton 8 as shown in FIG. 3.

Turning to the construction of a carton 8 of FIG. 2, from the blank 6 of FIG. 1. The blank is folded about a group of articles A. In the exemplary embodiment shown the group of articles consists of a group of 8 bottles arranged in two rows of four; however it is envisaged that other types of articles of potentially different number and configuration could be contained within a carton of the present invention.

The top panel 16 is brought down over the group of articles A and upper side panels 14, 18 are folded about the upper portions of the group of articles A. Lower side panels 12, 20 are then folded around the lower portions of the group of articles A.

The composite base of the carton 8 is formed by folding panels 10 and 22 about fold lines 11 and 21 respectively. The panels 10/22 are locked together by engaging the first part 56 of the complementary locking means with the second part 58 of the complementary locking means.

Upper and lower end flaps 38a, 38b, 24, 28, 30 and 34 are then folded about their respective fold lines 23, 25, 29, 31, 33, 35, 39 and 41 to enclose the ends of the articles A. Each of the upper end flaps 38a, 38b are linked to a respective one of the lower end flaps 24, 28, 30 and 34 such that folding any upper end flap 38a, 38b will result in substantially folding one of the lower end flaps 24, 28, 30, 34. Similarly, folding any one of the lower end flaps 24, 28, 30, 34 will result in substantially folding a respective one of the upper end flaps 38a, 38b. The upper end flaps 38a, 38b are connected to the top end flaps 26, 32 which top end flaps are then folded about fold lines 27 and 37, over the upper end flaps 38a, 38b. The connection between the upper end flaps and the top end flaps 26, 32 comprises sets of pairs of gusset panels 40a, 42a, which gusset panels are discussed in greater detail below.

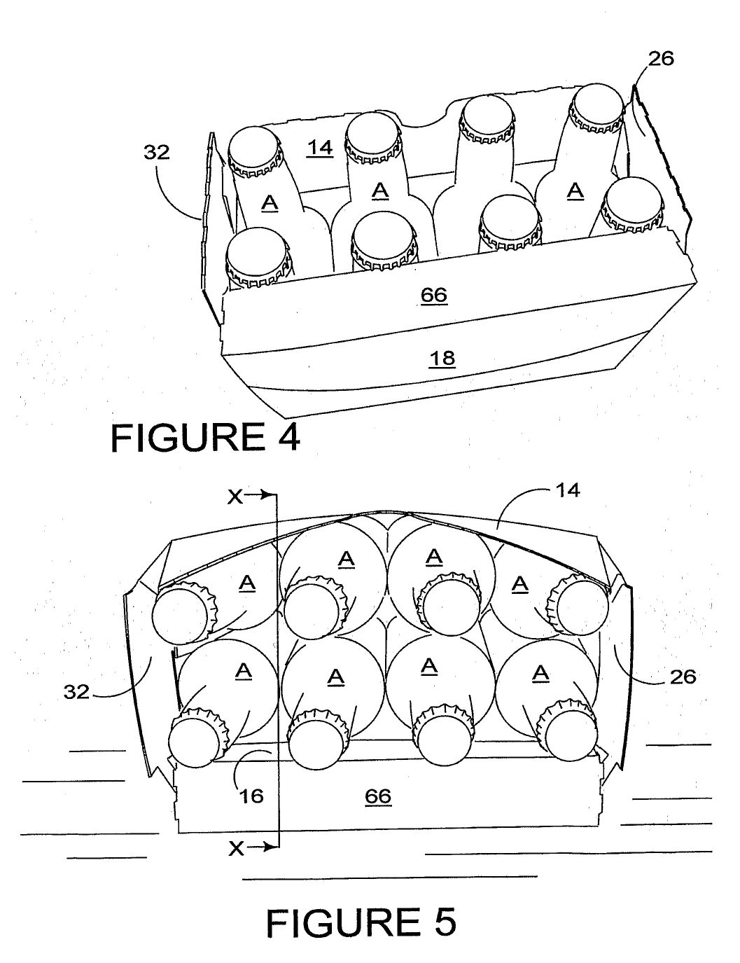

Turning now to FIGS. 4, 5 and 6, the access means is illustrated as having been severed from its connection with upper side wall 14 and with top end flaps 26, 32. The access means is thus free to hinge about fold line 17 that connects the access means to an edge of upper side wall 18.

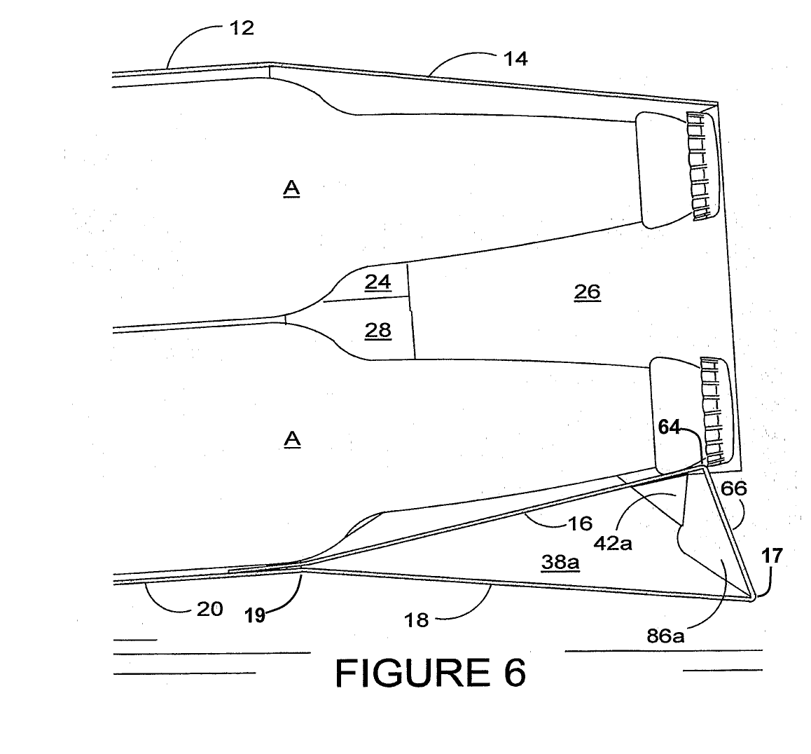

FIG. 6 is a cross section of FIG. 5 along the line ‘X-X’ and shows the way in which the access means is folded about fold line 64 such that the end of the access means, furthest from fold line 17, may be inserted between the articles and the upper side panel 18. Spacer panel 66 is defined between fold lines 64 and 17. The upper edge of the spacer panel engages with the underside of one or more articles A such that the edge of upper side panel 18 corresponding to fold line 17 is displaced away from the articles A. Thus the upper side panel 18 is caused to hinge about fold line 19 such that a plane containing the upper side panel 18 becomes substantially parallel to a plane containing the lower side panel 20. The spacer panel 66 therefore forms a brace between the surface upon which the carton is disposed and the underside of portions of one or more of the articles A.

The gusset panels 40a, 42a, 40b, 42b allow the upper side panel 18 to be folded into the plane of the lower side panel 20. The web arrangement of gusset panels partially unfolds as the upper side wall hinges about fold line 19. Thus upper side panel 18 remains connected to the top end wall panels 26, 32 via the web arrangement between the top end panel 26, 32 and the respective upper end flap 38a, 38b. The partial unfolding of the web arrangement of gusset panel allows the carton to be distorted from an original configuration, in which the upper side panel 18 tapers inwardly of the carton toward the top panel 16, into a distorted configuration in which the upper side panel is substantially in the plane of the lower side panel 20. Should the carton be disposed upon the lower side panel 20, this distortion effectively increases the dimensions of the lowermost surface of the carton and thus serves to increase its stability.

FIG. 5 illustrates the way in which the hinging of the upper side panel 18 about fold line 19 results in distortion of the carton. The web arrangement of gusset panels 40a, 42a, 40b, 42b, permits the distortion to take place without causing damage to the carton 8. This is achieved by the web arrangement of gusset panels 40a, 42a, 40b and 42b hinging with one another and with the respective top end flaps 26, 32 and upper side flaps 38a, 38b such that an aperture can be created between the adjacent edges of the top end panels 26, 32 and the upper side flaps 38a, 38b. This aperture provides sufficient spacing for the upper side panel 18 to be hinged substantially into the plane of the lower side panel, as described above.

The spacing of the edge the upper side panel 18, corresponding with fold line 17, away from the articles A, causes the upper side panel 18 to become substantially coplanar with the lower side panel 20. At this point, the carton may be disposed in an orientation better suited to dispensing the articles A, such that the upper side panel 18 and the lower side panel 20 are lowermost and the articles are orientated in two tiers on top of upper side panel 18 and lower side panel 20. In the first preferred embodiment illustrated in FIG. 5, the articles A are in rolling contact with the lower side panel 20 and with an uppermost edge, corresponding to hinge line 64, of spacer panel 66.

Referring to FIG. 6, the spacer panel 66 prevents the carton 8 from pivoting about the edge corresponding with fold line 19. This provides significant benefit to the user in that it thus not possible accidentally to cause such pivoting and thus for the articles A in either tier to unintentionally egress from the carton 8. It can also be seen from FIG. 6 how the access means, when folded between the articles A and the upper side panel 18, forms a tubular structure of substantially triangular cross section and thus offering a high level of rigidity and robustness.

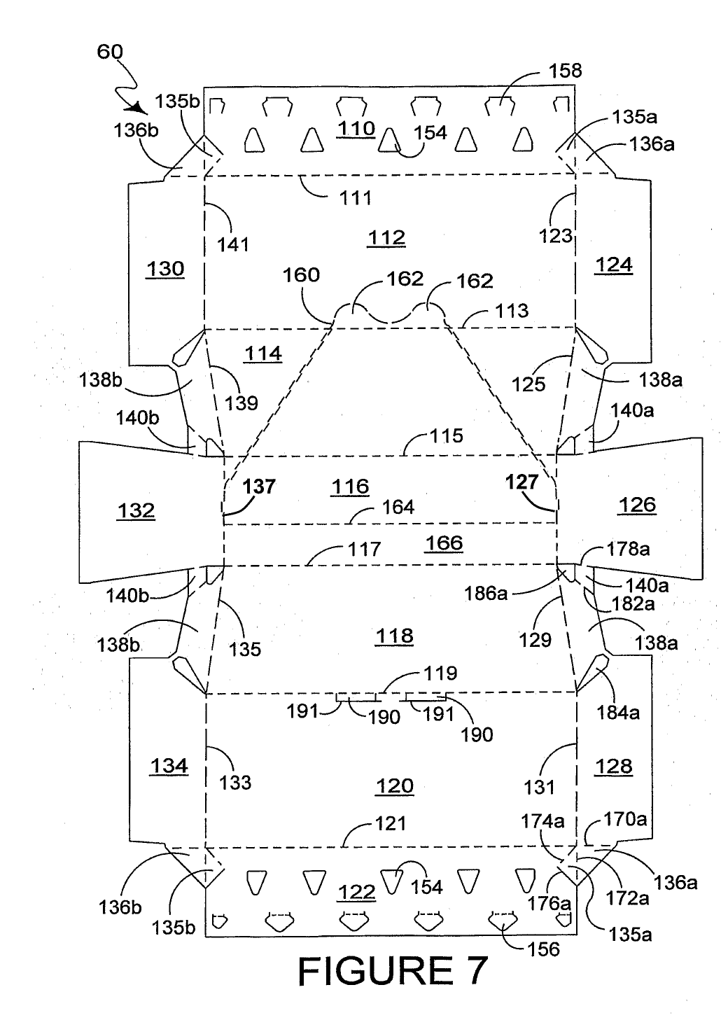

Turning now to FIGS. 7 to 11, illustrated within which is a second embodiment of the present invention, differing from the first only in a few elements. Those elements of the second preferred embodiment that correspond with like elements of the first embodiment have been given the same numbering and prefixed with the number ‘1’ for clarity. In the majority of respects, the details of composition and method of construction of the second preferred embodiment are identical to those of the first embodiment described above, and therefore only those areas that differ will be described below.

Contrasting FIG. 7 with FIG. 1 illustrates that the most fundamental difference between the two embodiments is that the access means of the second embodiment comprises a far greater portion of the upper side panel 114 and goes on to extend into the lower side panel 112, where it terminates in two finger tabs 162. The access means will be described in greater detail below.

Conversely, the access means of the second preferred embodiment comprises a smaller portion of the top panel 116 than the first. Only a portion of the fold lines 127 and 137, connecting the top end panels 126 and 132 with the top panel 116, are frangible, the remainder being a non-frangible fold line. The frangible portion of each of fold line 127 and 137 commences at the intersection of frangible line 160 with the fold line 127, 137, and continues until the intersection of fold line 164 with the fold line 127, 137.

A further difference between the first and second preferred embodiments is that the web arrangement gusset the top end panels 126, 132 with the upper end flaps 138a, 138b, consists of only one gusset panel 140a, 140b rather than the two gusset panels used in the first preferred embodiment. This is because the second embodiment does not require distortion of the carton in order to increase the stability of the carton when disposed upon its lower side panel.

Turning to the access means of the second preferred embodiment, the access means is defined between frangible line 160, the frangible portions of fold line 127, 137 and fold line 164. The frangible line 160 commences in the top panel 116 where it intersects with the fold lines 127, 137 between fold line 164 and fold line 115. The frangible line 160 diverges away from fold line 127, 137 across fold line 115, continuing through upper side panel 114 and across fold line 113 before converging to two adjacent finger tabs 162 in lower side panel 112. FIG. 7 also shows the position of spacer panel 166 as defined between fold line 115 and fold line 164 in the top panel 116.

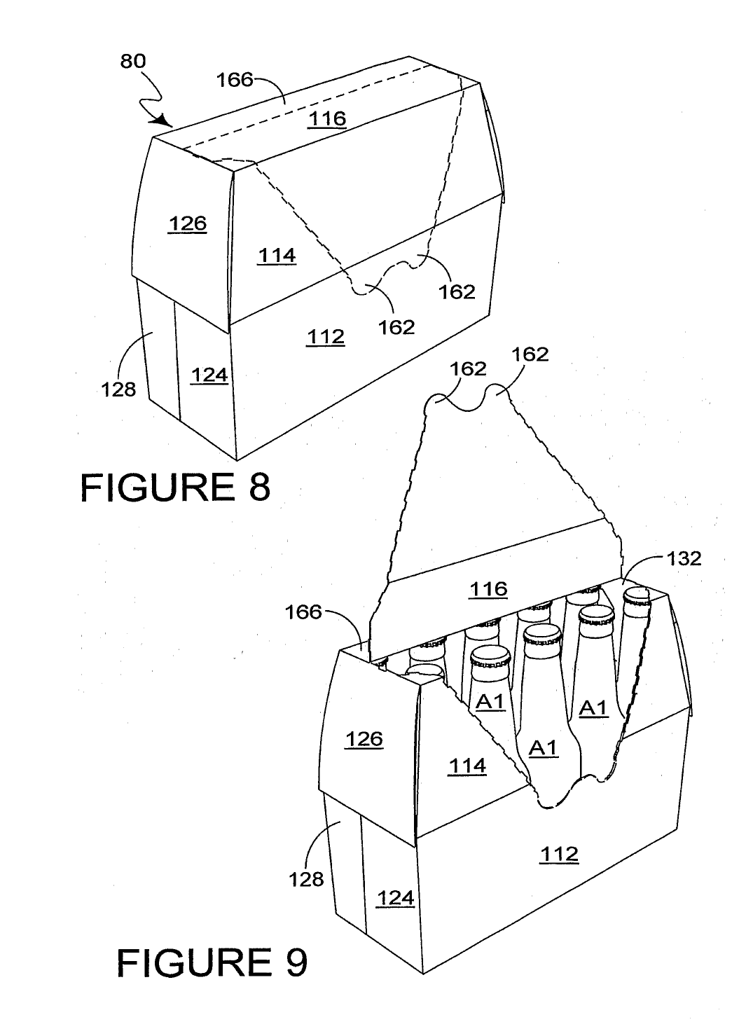

Turning to FIGS. 8 and 9, the set up carton 18 is illustrated before and after the access means has been severed from the top panel 116, upper side panel 114 and lower side panel 112. Unlike the first preferred embodiment, the top panel 116 is left partially intact after the access panel has been freed to hinge about fold line 164, the integrity of the top panel is maintained by remaining portions of top panel 116 at the corners where the top end panels 126, 132, the upper side panel 114 and the top panel 116 meet.

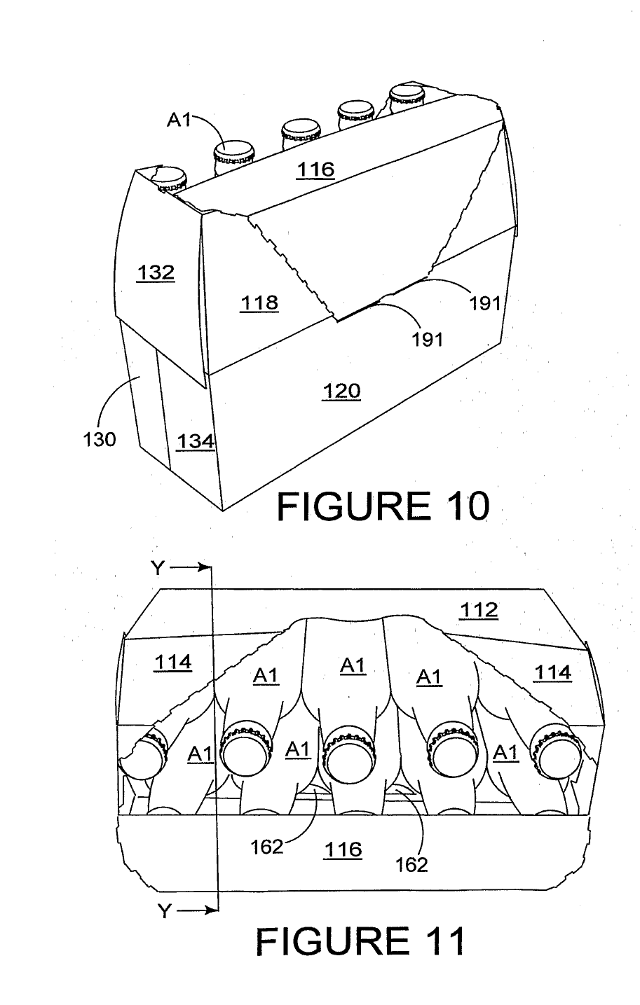

FIGS. 10, 11 and 12 illustrate the set up carton of FIG. 9 wherein the access means has been folded about fold line 164 such that the spacer panel 166 is in substantially face contacting relationship with the remaining portion of top panel 116. The spacer panel is, however, wider than the remaining portion of top panel 116, and so the fold line 115 is offset from the fold line 117 between the remaining portion of the top panel 116 and the upper side panel 118.

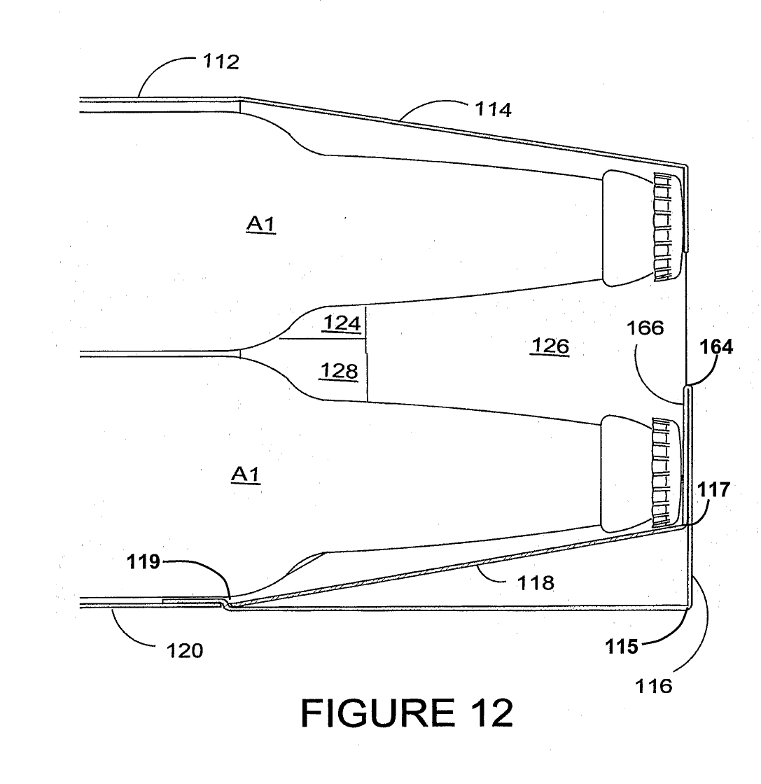

FIGS. 11 and 12 together show the second preferred embodiment disposed on its side and ready to dispense articles A. Lower side panel 120 is lower most. FIGS. 11 and 12 show that the access means has been folded about fold line 115, illustrated in FIG. 7, such that the finger tabs in the end of the access means have been located in receiving slits 191. The receiving slits 191 each have corresponding receiving flaps 190 that hinge to the lower side panel 120 such that the finger tabs 162 may pass through the resulting aperture and thus locate interior of the carton between the articles A and the lower side panel 120.

FIG. 12 shows a cross section of the carton of FIG. 10 through line ‘Y-Y’ and illustrates the way in which the portion of the access means between fold line 115 and the finger tabs 162 is substantially coplanar with the lower side panel 120 and thus how the lowermost surface of the carton effectively extends the full length of the carton. Pivoting of the carton 18 about the edge coinciding with fold line 115 is therefore prevented by the spacer panel 166 hinged between the upper edge of the remaining portion of the top panel 116 and the portion of the access means substantially in the plane of the lowermost surface of the carton along fold line 115.

Thus, both the first and second preferred embodiments of the present invention both provide a means of bracing the terminal end of a tapered wall against the horizontal plane, so as to prevent the articles A contained within the carton 8/18 from being angled downwardly of horizontal and the unintentionally egress of the articles A from the carton 8/18.

It is envisaged that the features of the embodiment herein described that relate to the geometry of the set up carton 8/18 may be altered without departing from the scope of the present invention. For example the carton need not be of the wrap around type but could be a fully enclosed carton, basket carrier or other known carton style. Furthermore, the carton may not be gabled as in the preferred embodiments, but may instead be entirely tapered between its base and top panels. In such a situation, the access means described herein could result in an added benefit of putting the articles in an orientation that would prevent or at least mitigate from them unintentionally exiting the carton. Still further, the invention could be applied to cartons of substantially rectangular geometry. In such a case, the access means could offer the added benefit of inclining the articles so as to present them to the user, in preparation of user removing an article. Such an added benefit could also be gained from the use of the access means with cartons of the other geometries described above.

It is envisaged that means of forming a base that is other than a composite of two or more panels may be employed whilst still gaining the benefit of the present invention. It will also be appreciated that the specific arrangement, described herein, for achieving the engagement of panels 10, 22 to form the composite base, is not limiting and is offered on an exemplary basis only.

It will be recognized that as used herein, directional references such as “top”, “bottom”, “front”, “back”, “end”, “side”, “inner”, “outer”, “upper” and “lower” do not limit the respective panels from one another. Any reference to hinged connection should not be construed as necessarily referring to a single fold line only; indeed it is envisaged that hinged connection can be formed from one or more of the following, a score line, a frangible line or a fold line without departing from the scope of invention.

1-25. (canceled)

26. A carton for packaging articles arranged in rows, the carton comprising a top panel, side panels, a bottom panel and an integral tear-open access feature provided by said top panel and one of said side panels to gain access to said articles, said integral tear-open access feature being hingedly connected to, and partially severable from, the carton such that when severed from the carton, said integral tear-open access feature is foldable to an article-supporting position wherein said integral tear-open access feature cooperates with at least the other of said side panels to provide a platform structure in which a first part of said tear-open access feature is disposed in contact with said other side panel and a second part of said integral tear-open access feature is spaced from said other side panel to enhance the stability of the carton when the carton is placed on said other side panel.

27. The carton of claim 26, wherein said first and second parts are disposed internally of the carton and provide a support for one end of each of said articles which otherwise may be resting on said other side panel.

28. The carton of claim 26, wherein said first and second parts together with facing parts of said other side panel form said platform structure.

29. The carton of claim 27, wherein an edge for supporting said articles is created by folding said integral tear-open access feature about a first fold line defined within said integral tear-open access feature.

30. The carton of claim 29, wherein a free edge of said integral tear-open access feature, opposite said first fold line, is positioned between the remaining contents of the carton and said other side panel.

31. The carton of claim 30, further comprising a web arrangement connecting between adjacent panels of the carton so that at least a part of said other side panel is pivotally movable in such a manner that both said at least a part and the other part of said other side panel come into contact with a supporting surface when the carton is placed on said supporting surface with said other side panel down.

32. The carton of claim 31, wherein said web arrangement comprises first and second gusset panels hinged together about one common edge, wherein an edge of said first gusset panel opposite to said common edge is hinged to a first panel of the carton, wherein an edge of said second gusset panel opposite to said common edge is hinged to a second panel of the carton, and wherein said adjacent panels of the carton are said first and second panels respectively.

33. The carton of claim 26, wherein at least said second part is positioned externally of the carton to allow part of said other side panel to be spaced above said second part when said carton is placed on said other side panel.

34. The carton of claim 33, wherein a free edge of said integral tear-open access feature engages with said other side panel of the carton.

35. The carton of claim 34, wherein said other side panel of the carton is provided with one or more apertures for receiving said free edge of said integral tear-open access feature.

36. A carton for packaging articles arranged in rows, the carton comprising a top panel, side panels, a bottom panel and an integral tear-open access means, provided by said top panel and one of said side panels, for facilitating access to said articles, said tear-open access means being hingedly connected to, and partially severable from, the carton such that when said integral tear-open access means is severed from the carton and the carton is placed on the other of said side panels, said integral tear-open access means is foldable about a first fold line and an adjacent second fold line to form a platform structure, wherein upon formation of said platform structure, a part of said integral tear-open access means is spaced from the said other side panel to enhances the stability of the carton.

37. The carton of claim 36 wherein said part of said integral tear-open access means is disposed internally of the carton when said platform structure is formed, and said part provides a support for one end of each of said articles which otherwise may be resting on said other side panel.

38. A tear-open access feature for use in a carton wherein said access feature is struck from panels of said carton and defined within said panels between at least one frangible line and a first fold line, said frangible line being breakable to allow a user to gain access to articles contained within said carton, said access feature being hinged to said carton by said first fold line, said access feature comprising a second fold line such that said access feature can be folded about said second fold line in order to place a portion of said access feature between said articles and a panel of said carton, thereby providing support for the carton contents.

39. The access feature of claim 38 wherein said second fold line is parallel to said first fold line.

40. The access feature of to claim 38 wherein said access feature comprises a finger tab to facilitate breaking said frangible line.

41. A blank for forming a carton comprising a linear series of panels for forming a top, opposed side and bottom panels of a set up carton, wherein the blank further comprises an integral tear-open access means provided by said top panel and one of said side panels of the set up carton, for facilitating access to articles contained within the set up carton, said tear-open access means being hingedly connected to said set up carton about a first fold line, and wherein when said set up carton is placed on a surface such that the other of said side panels is lowermost, said tear-open access means is foldable about said first fold line to contact said other side panel in such a manner that said tear-open access means provides a platform for enhancing the stability of the carton.

42. The blank of claim 41 further comprising a web arrangement for permitting deformation of said set up carton, wherein said web arrangement comprises first and second gusset panels hinged together about one common edge, wherein an edge of said first gusset panel opposite said common edge is hinged to a first panel of said set up carton, and wherein an edge of said second gusset panel opposite said common edge is hinged to a second panel of said set up carton, and wherein said first and second panels of the set up carton are adjacent to each other.
